(19) United States
(12) Patent Application Publication
(10) Pub. No.: US 2023/0384133 A1
(43) Pub. Date: Nov. 30, 2023

(54) Multiphase Measurement System With Electromagnetic Water Cut Meter And Waxy Solids Control Systems

(71) Applicant: NeoTek Energy, Inc., Plano, TX (US)

(72) Inventors: David H. Reasoner, Dallas, TX (US); Douglas B. Weiner, Plano, TX (US); Richard C. Eden, Briarcliff, TX (US); John E. Finklea, Richardson, TX (US)

(21) Appl. No.: 18/326,427

(22) Filed: May 31, 2023

Related U.S. Application Data
(60) Provisional application No. 63/347,398, filed on May 31, 2022.
(60) Provisional application No. 63/347,421, filed on May 31, 2022.

(51) Int. Cl. G01F 1/74; H01Q 1/42; F17D 5/00; B01D 19/00

(52) U.S. Cl. CPC G01F 1/74; H01Q 1/42; F17D 5/00; B01D 19/0068; F17D 1/005

(57) ABSTRACT

A separator and measurement system includes a separator arranged to separate gas from liquid. A gas line assembly is connected to the test separator to receive gas, with the gas line assembly having a gas flow meter. A liquid line assembly can be connected to the test separator to receive liquid. In one embodiment a water cut meter having a flow housing that defines a cavity, a plurality of antenna connected to the flow housing by antenna connector, and a protective covering for each of the plurality of antenna can be a component of the separator and measurement system.

### CROSS-REFERENCE TO RELATED PATENT APPLICATIONS

This application claims the priority benefit of U.S. Patent Application No. 63/347,398, filed May 31, 2022, and U.S. Patent Application No. 63/347,421, filed May 31, 2022, both of which are hereby incorporated by reference in their entirety.

### TECHNICAL FIELD

The present disclosure generally relates to improved water cut meters suitable for use in systems that support waxy solid mitigation and provide continuous or near real time analysis of multi-phase fluids that contain oil, gas, and water.

### BACKGROUND

Wellbore fluids from oil or gas wells drilled into conventional petroleum reservoirs are often multi-phase fluids that contain oil, gas and water. The amount and mixture of these components can vary over time making wellbore fluid difficult to characterize and identify. The properties, such as composition, flow rate, and viscosity of each component (oil, water, and gas), can vary from even closely spaced wells. Additionally, quantities of each phase vary with time, with the oil and gas fractions typically reducing with respect to the water fraction. Monitoring provides key insights to the wells ongoing operation and performance.

Flow rates of the components of a multi-phase flow can be measured with a test separator. Since a conventional test separator can be expensive and bulky, it is often not practical to have a test separator continuously measuring production on every well. Instead, a small number of test separators (1-5) are used per oil field, with each well being routed through the test separator at regular intervals. When a well is routed through a test separator, the conditions for the well change, which can distort production and multi-phase fluid conditions enough that the measurement does not represent the well conditions correctly. A test separator can also be slow because of the long separation time for oil and water. The settling time can be particularly long in wet gas applications with small liquid fractions that require a long time to fill up the separator.

Even with a test separator, measuring properties of these components can be a slow and complex process. For example, flow rate of a multi-phase fluid is difficult to measure because flow rate of the gas can greatly differ from that of the oil. Variations in flow patterns can also affect measurements. Flow patterns can easily change in response to changes in liquid or gas distribution and the variations in physical properties of each multi-phase fluid component.

Measurement systems using cyclone separation techniques that are equipped with flow meters and other multi-phase sensor systems have been used for multi-phase wellbore fluid separation and monitoring. Flow through the oil and water outlets of conventional test separators are not continuous due to operation of dump valves. Flow must be stopped for a long period of time while fluids flow into the separator. When liquids reach a threshold the valves open and liquids flow rapidly through the outlets. This results in an averaging function with a sample rate that is typically about one sample every 60 minutes. Commonly, separators using cyclone separation techniques are equipped with flow meters and other multi-phase sensor systems for multi-phase wellbore fluid monitoring. Such a separator consists of a vertical pipe with a tangential inclined inlet and outlets for gas and liquid. Tangential flow from the inlet into the body of the cyclone separator causes the flow to swirl with sufficient velocity to produce centripetal forces on the entrained gas and liquids that push the liquid radially outward and downward toward a liquid exit, while the gas is driven inward and upward toward a gas exit. Unfortunately, cyclone separators are difficult to design and operate without having liquid carryover and/or gas carry under, which cause inaccuracies in the measurement equipment. In vertical tubing or risers of cyclone separators, buoyancy effects due to density differences between the gas and liquid cause the gas to rise much faster than the liquid, increasing slip between the gas and liquid. At low fluid velocities, wellbore liquids tend to accumulate at low pockets in horizontal pipes while gas coalesces into large and small bubbles, which propagate faster than the liquid, thereby increasing the slip between gas and liquid. These and other factors make providing real-time, high sample rate oil and water measurements difficult.

What is needed is a low liquid retention time, two phase separator that permits liquid to flow continuously and can provide accurate liquid level sensing using differential pressure sensors. Ideally, accurate, real-time oil and water flow rates can be measured at minute or second time scales to permit real-time or near realtime adjustment of well operating conditions, over a wide range of input flow conditions. This near real-time measurement capability provides the ability to gain significant insights into well and reservoir operation. These can include but are not limited to slug detection and mitigation, choke control, as well as gas-lift optimization. Such systems can be equipped with improved water cut meters and use structures and methods to reduce waxy solid or other solid accumulation in piping, sensor surfaces, or antennas.

Even with the use of low retention time separators, the sensor attached to them must be capable of accurate operation in the well fluid environment. Additional problems are associated with water cut meters especially in environments with waxy solid build ups, consisting of a mixture of saturated hydrocarbons. While there many types of water cut meters used commercially those based on some type of microwave principles are the most common. Currently, there are three commercial water-cut methods using different microwave principles: 1) microwave dielectric properties of mixtures can be measured using the electromagnetic resonant cavity method; this method becomes inaccurate when the energy loss portion of the permittivity becomes significant because the shift in the resonant frequency of the cavity becomes very difficult to predict when the imaginary part of the permittivity becomes dominant, 2) using an oscillator load pull principle by creating a standing wave in the mixture and noting changes in frequency of the wave. However, the size of the unit required is quite large, and 3) measuring the concentration of the two fluids through the transmission of electromagnetic waves. One transmitter is used for transmitting a signal and two receivers for receiving a signal. The use of two receivers provides two output signals to determine the concentration, with the bulk dielectric properties of the fluids being measured by signals received from two antennas spaced at different distances from a single source transmitter. The size of the unit can be quite small by using frequencies typically in the GHz range.

Commonly when the concentration of two fluids are measured by changes in transmission of electromagnetic waves, a single transmitter is used for transmitting a signal and two receivers are used for receiving a signal. The use of two receivers provides two output signals to determine the concentration. Bulk dielectric properties of the fluids can be measured by signals received from two antennas spaced at different distances from a single source transmitter.

Unfortunately, such water cut meters can be limited by durability of the antennas in the liquid environment consisting of corrosive fluids typically found in many applications. Further, use of a single dedicated transmitter and only two dedicated receivers can reduce accuracy.

Another problem associated with water cut meters and other sensors monitoring flow characteristics results from paraffin or other solid accumulation (e.g. waxy solids build-up) on sensor elements, including antennas. Chemical treatment can be used to remove accumulation of solids, but this approach is corrective and not preventative. Chemical treatment can be cost prohibitive. Chemical treatment typically requires additional fluid processing downstream to remove the chemicals. While application of heat is a known mitigation technique for waxy hydrocarbon solids, it is often not sufficient.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates flow through a separator and measurement system;

FIGS. 2(i), 2(ii), and 2(iii) illustrate respective front, back and side views of a separator and measurement system.

FIG. 2(iv) is a detail illustrating positioning and components of a gas line assembly for a separator and measurement system;

FIG. 2(v) is a detail illustrating positioning and components of a liquid line assembly for a separator and measurement system;

FIGS. 3(i), 3(ii), and 3(iii) illustrate one embodiment of water cut meter;

FIGS. 4(i), 4(ii) and 4(iii) illustrate another embodiment of a water cut meter with dual transmit and receive antenna;

FIGS. 5(i) and 5(ii) illustrate another embodiment of a water cut meter with four antennas; and

FIG. 6 illustrates a water cut meter with a heating element to assist in paraffin mitigation.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

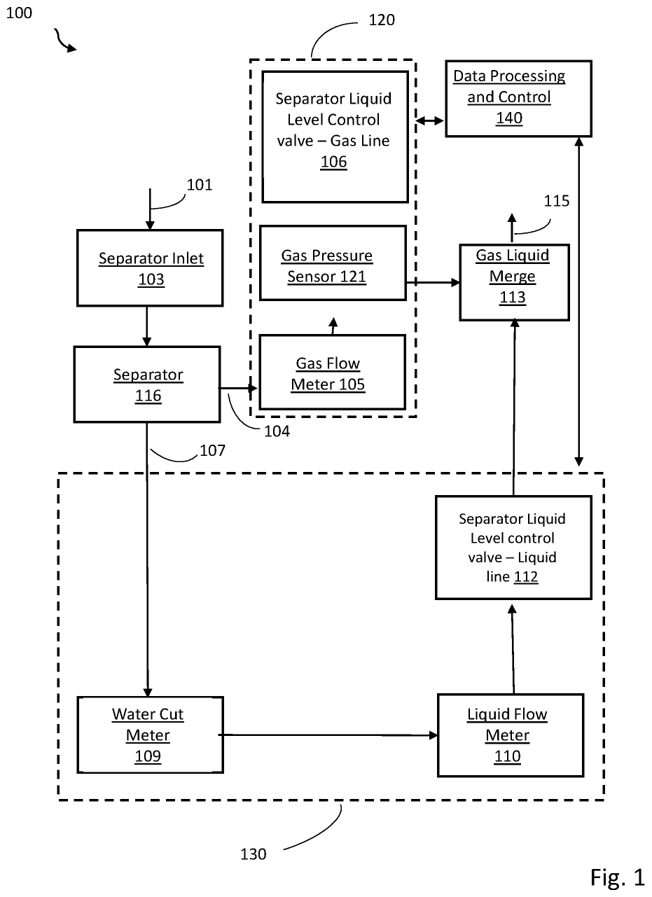

FIG. 1 illustrates flow through a low retention time separator and measurement system 100 suitable for wellbore fluid analysis. In this embodiment, multi-phase fluids can flow from a well into system inlet 101. The multi-phase fluids can pass into a separator inlet 103 to a two phase gas-liquid separator 116. Gas flows from the separator gas outlet 104 into a gas line assembly 120. In the gas line assembly 120, gas flows through one or more gas flow meters and sensors such as a gas flow meter 105 and an absolute gas pressure sensor 221. The gas then flows through the separator liquid level control valve-gas line 106. Ultimately, gas merges with liquid in the gas-liquid merge 113 before leaving the separator and measurement system 100.

After passing through the separator 116 and being separated from gas, liquid flows from a separator liquid outlet 107 into a liquid line assembly 130. Liquid flows through a liquid flow meter and sensors such as a water cut meter 109, continues through a liquid flow meter 110 and then passes through a separator liquid level control valve—liquid line 112 and merges with gas in a gas-liquid merge 113. The merged gas and liquid flow through the pipe assembly for flow conditioning, and then to system outlet 115.

During operation of system 100, sensor measurements including liquid and/or gas flow, as well as water cut meter 109 are taken at minute or less intervals. In some embodiments, measurements are taken at 10 second intervals. The system 100 is connected to a data processing and control system 140 that can be local, connected via wired or wireless connections to a remote data processing center, or have both local and remote data analysis and system 100 control capabilities. In some embodiments, machine learning algorithms supported by data processing and control system 140 can be utilized in a liquid level control algorithm to recognize periodic slugs of liquid and/or gas and manage the liquid level in anticipation of changes in fluid flow rate and/or changes in gas volume fraction. This will increase the maximum average fluid flow rates that can be handled by a separator vessel of a given size.

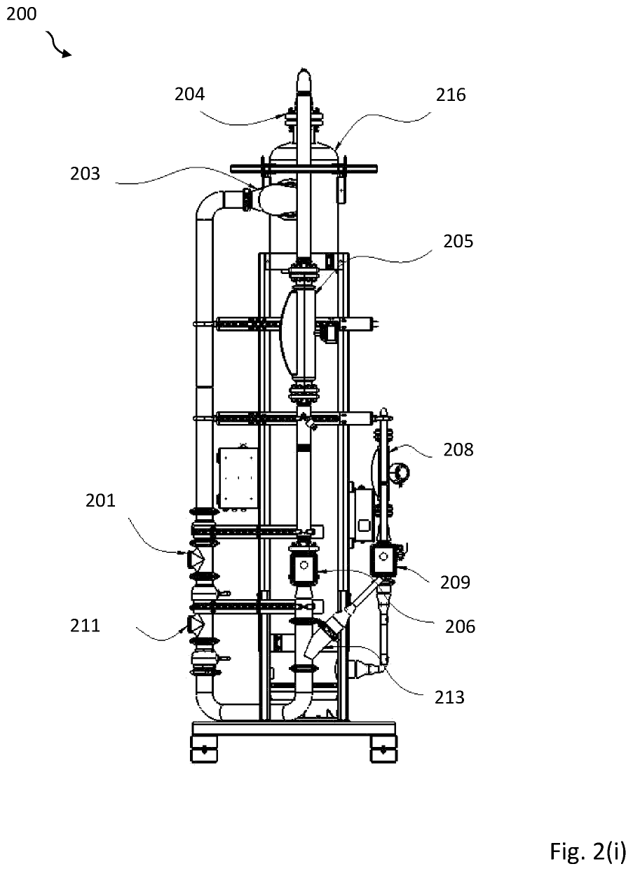

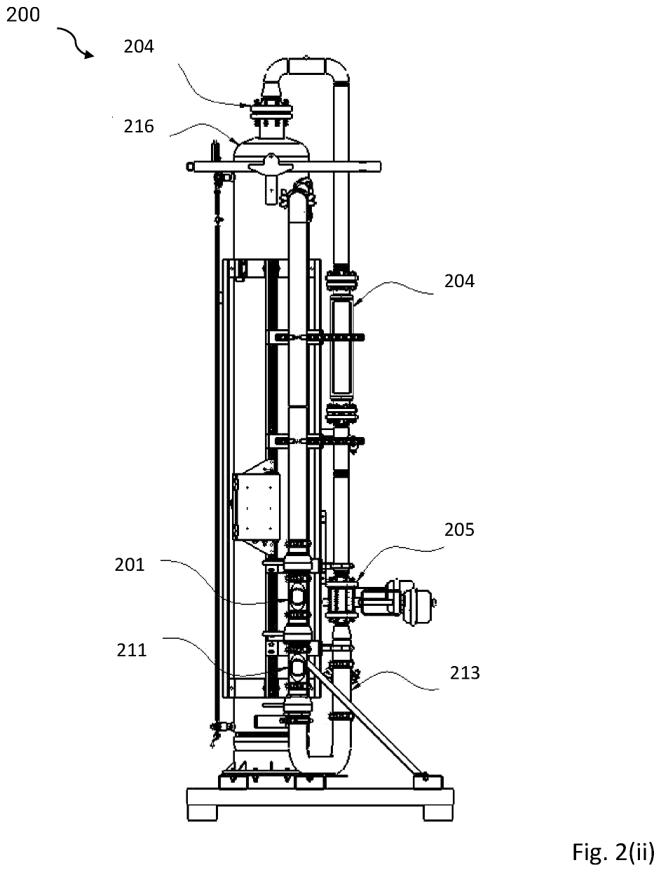

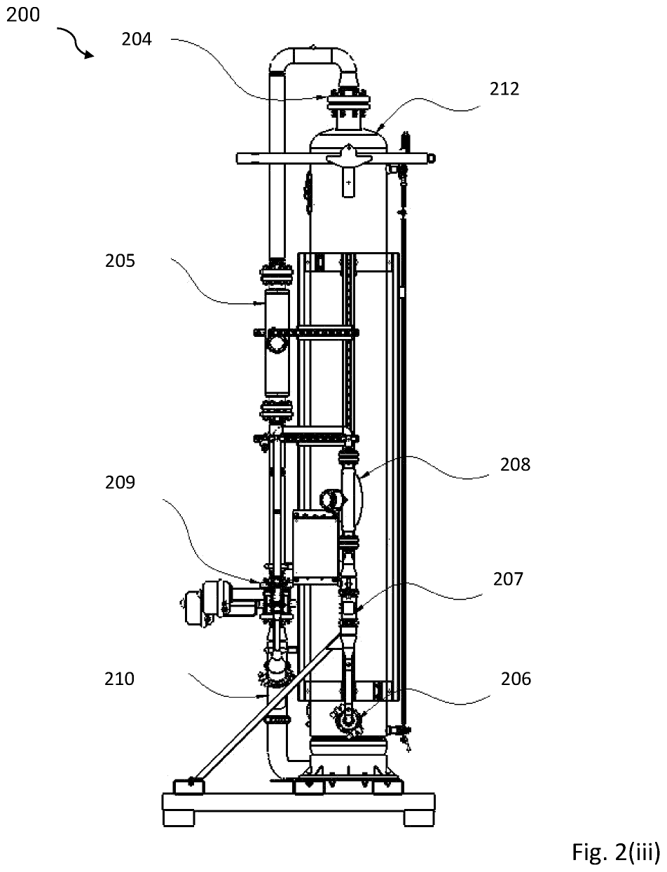

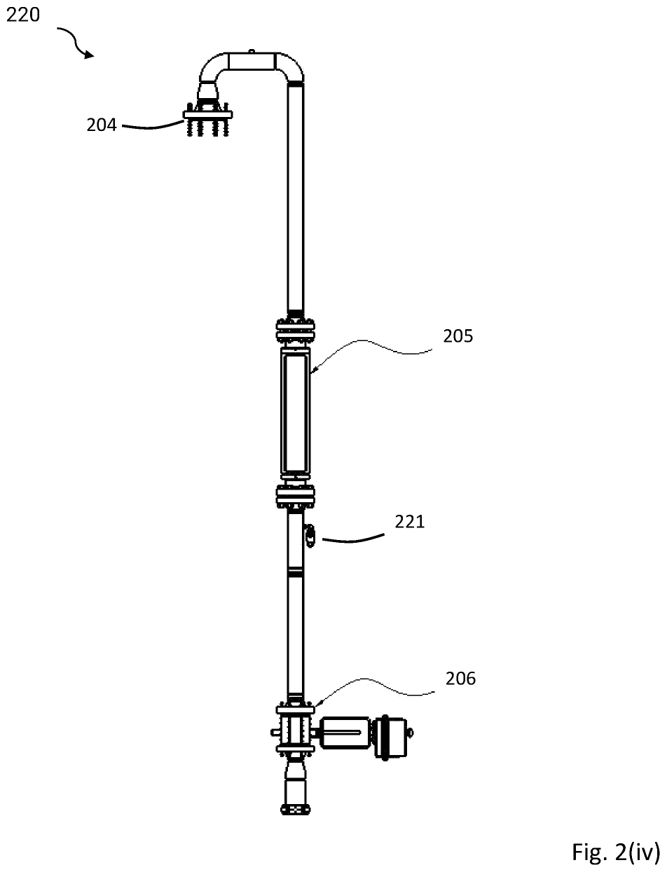

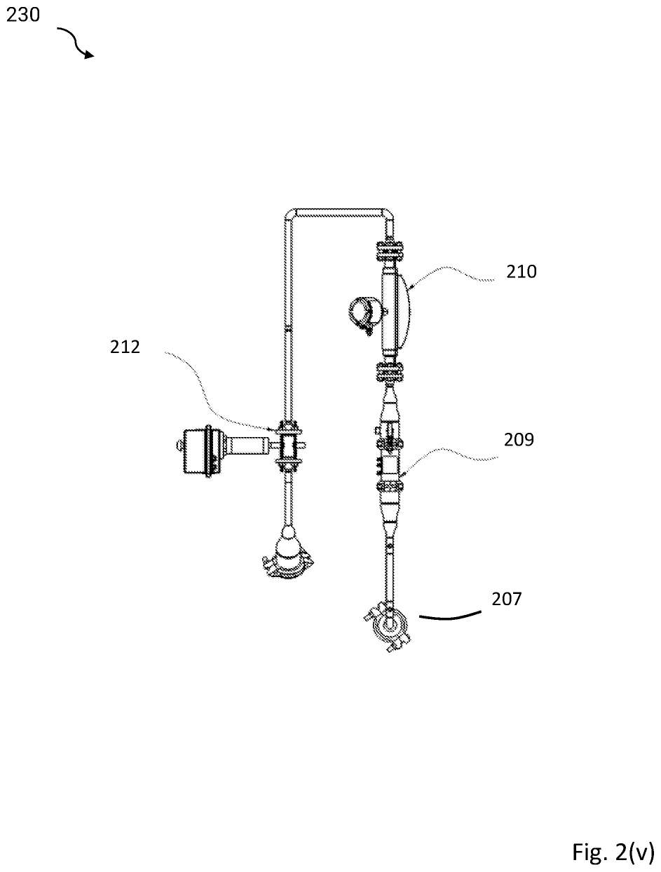

FIGS. 2(i), 2(ii), and 2(iii) illustrate respective front, back and side views of a separator and measurement system 200 that implements one embodiment of a system such as discussed with respect to FIG. 1. Detailed views of selected components of separator and measurement system 200 are illustrated in FIGS. 2(iv) and 2(v).

Fluid flow through system separator and measurement system 200 can begin with inlet 201. The multi-phase fluids can pass through a separator inlet 203 into a two phase gas-liquid separator 216. In one embodiment, the separator inlet 203 is positioned near a top of the separator 216. More specifically, the separator inlet 203 is positioned in a top half, top third, or top 15% of separator height, typically within 50 centimeters of the top. This location allows maximization of fluid handling capability of the separator 216 and permits relatively small separators to be used for handling a defined liquid capacity (as compared to separators with inlets positioned lower or in a bottom half of the separator).

After passing into the separator 216, gas flows from the separator gas outlet 204 into a gas line assembly 220 as seen in FIG. 2(iv). In the gas line assembly 220, gas flows through one or more gas flow meters and sensors such as a gas flow meter 205 and an absolute gas pressure sensor 221. The gas then flows through the separator liquid level control valve-gas line 206. Ultimately, gas merges with liquid in the gas-liquid merge 213 (seen in FIG. 2(ii)) before leaving the separator and measurement system 200.

After passing through the separator 216 and being separated from gas, liquid flows from a separator liquid outlet 207 into a liquid line assembly 230 as seen in FIG. 2(v). Liquid flows through a liquid flow meters and sensors such as a water cut meter 209, continues through a liquid flow meter 210 and then passes through a separator liquid level control valve-liquid line 212. Liquid merges with gas in the gas-liquid merge 213 (seen in FIG. 2(i)) before leaving the separator and measurement system 200. The merged gas and liquid flow through the pipe assembly for flow conditioning, and then to system outlet 215.

During operation of system 200, sensor measurements including liquid and/or gas flow, as well as water cut meter 209 are taken at minute or less intervals. In some embodiments, measurements are taken at 10 second intervals. The system 200 is connected to a data processing and control system (not shown) that can be local, connected via wired or wireless connections to a remote data processing center, or have both local and remote data analysis and system control capabilities (such as discussed with respect to data processing and control system 140 of FIG. 1). In some embodiments, machine learning algorithms supported by data processing and control system can be utilized in a liquid level control algorithm to recognize periodic slugs of liquid and/or gas and manage the liquid level in anticipation of changes in fluid flow rate and/or changes in gas volume fraction. This will increase the maximum average fluid flow rates that can be handled by a separator vessel of a given size.

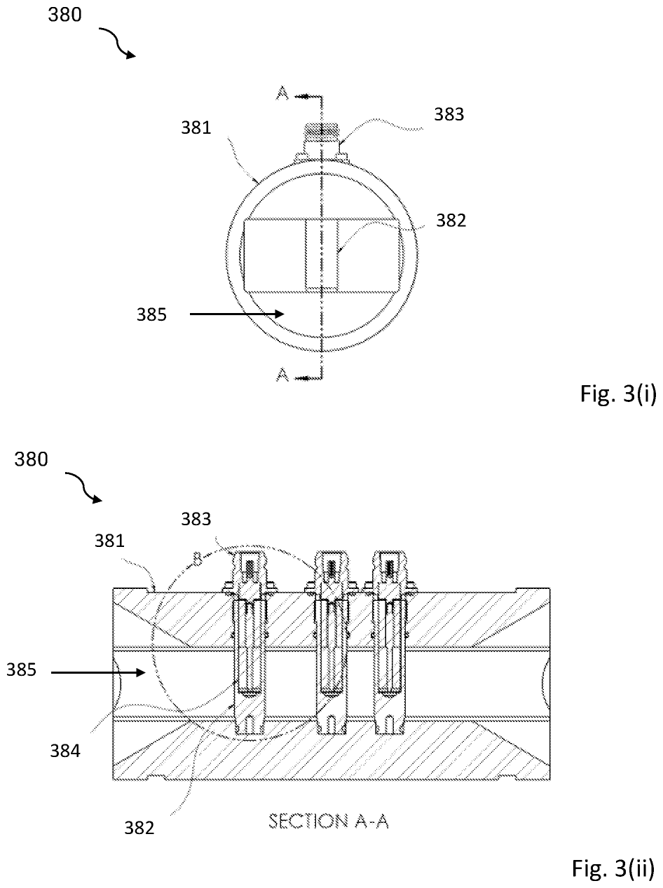

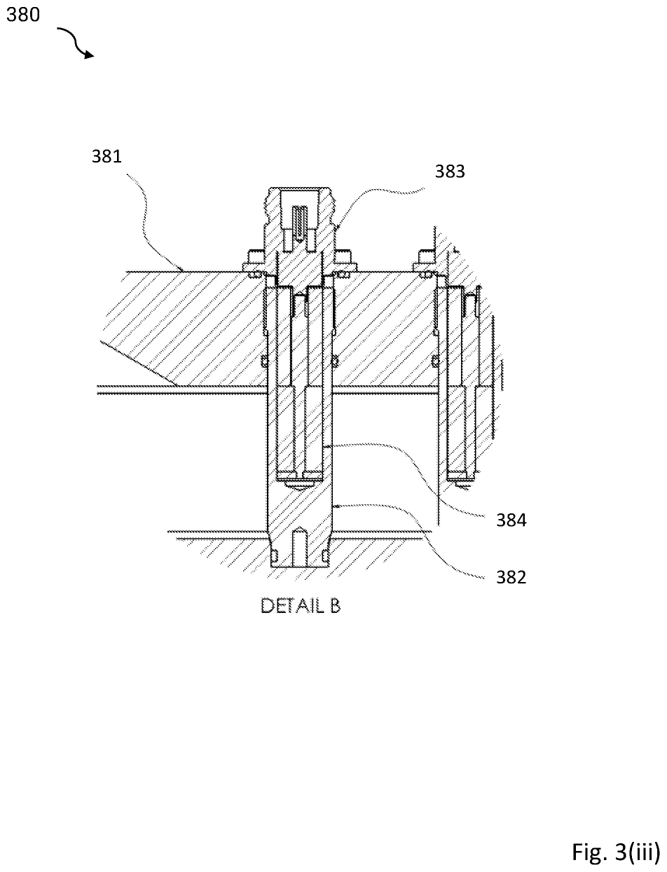

FIGS. 3(i), 3(ii), and 3(iii) illustrate in cross section (FIG. 3(i) and FIG. 3(ii)), and in detail (FIG. 3(iii)), one embodiment of a water cut meter 380. In this embodiment, the water cut meter 380 has a flow housing 381 with cavity 385, antenna 384, antenna connector 383, and protective covering 382. The antenna 384 is installed inside the protective covering 382, which can be formed to span an entire height of the cavity 385. The protective covering 382 can be formed of plastic or other material that is nearly transparent to electromagnetic waves, so it does not affect measurement accuracy. The covering material strength can be sufficient to withstand high pressure differences between the outside and the inside of the protective covering 382. The protective covering 382 is durable in the presence of corrosive chemicals. The use of this covering prevents antenna 384 and/or other contained sensors or components from exposure to corrosive fluids and high temperatures commonly seen in a wellbore fluid measurement environment. To improve mechanical strength, the protective covering 382 can be mechanically supported on both ends. Such mechanical support reduces torque that would be applied at the connector side due to the force on the antenna from the fluid flow velocity and mass.

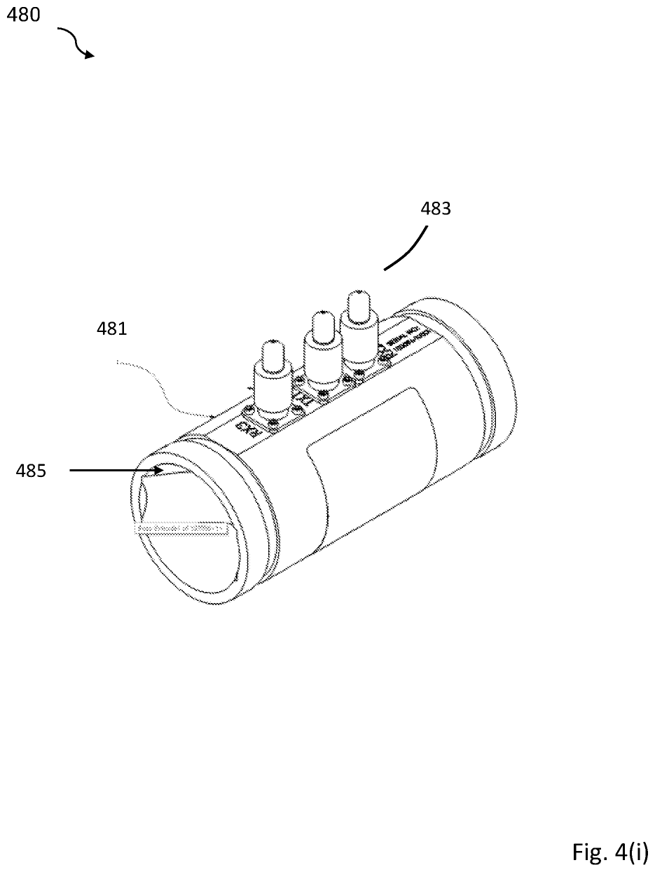

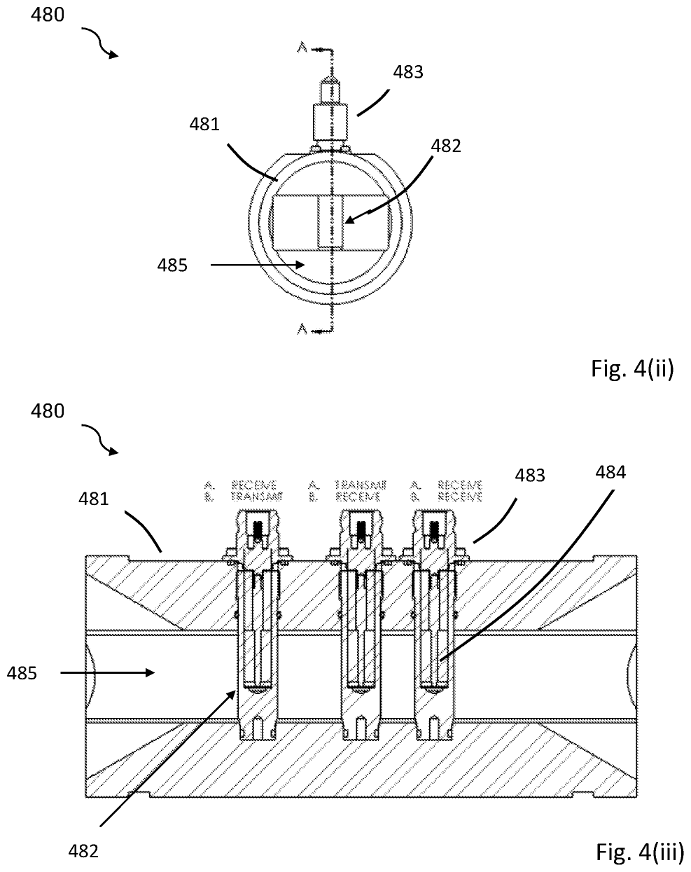

FIGS. 4(i), 4(ii) and 4(iii) illustrate in perspective view (FIG. 4(i)) and cross section FIG. 4(ii)) and (FIG. 4(iii)), one embodiment of a water cut meter 480. In this embodiment, the water cut meter 480 has a flow housing 481 with cavity 485, three antennas 484, antenna connectors 483, and protective coverings 482. In this embodiment, a switch or switches in an electronics assembly (not shown) that controls electromagnetic transmit and receive functionality of each antenna provides additional measured data that improves accuracy across a wider range of oil—water mixtures. For cases of high water and low oil receive antennas need to be relatively close to the transmit antenna due to high loss and short wavelength of the electromagnetic signal. For cases of high oil and low water receive antennas need to relatively far from the transmit antenna due to low loss and long wavelength.

The transmit/receive switching approach is illustrated in 4(iii). For case A, the electromagnetic signal is transmitted from a middle antenna and received by the two outside antennas. Case A provides accurate results in conditions of high water and low oil. For case B, the electromagnetic signal is transmitted on the left outside antenna and received by the middle and right outside antennas. The electromagnetic propagation distance from the left outside transmit antenna to the right outside receive antenna is significantly longer than the propagation distance to either antenna in case A. Case B provides accurate results in conditions of high oil and low water.

In addition to the accuracy improvements, the additional data provided by the transmit/receive switch improves the ability to detect wax solid build-up on or between the antennas as the solid will not build up equally. This additional data can also be used to correct for wax build-up.

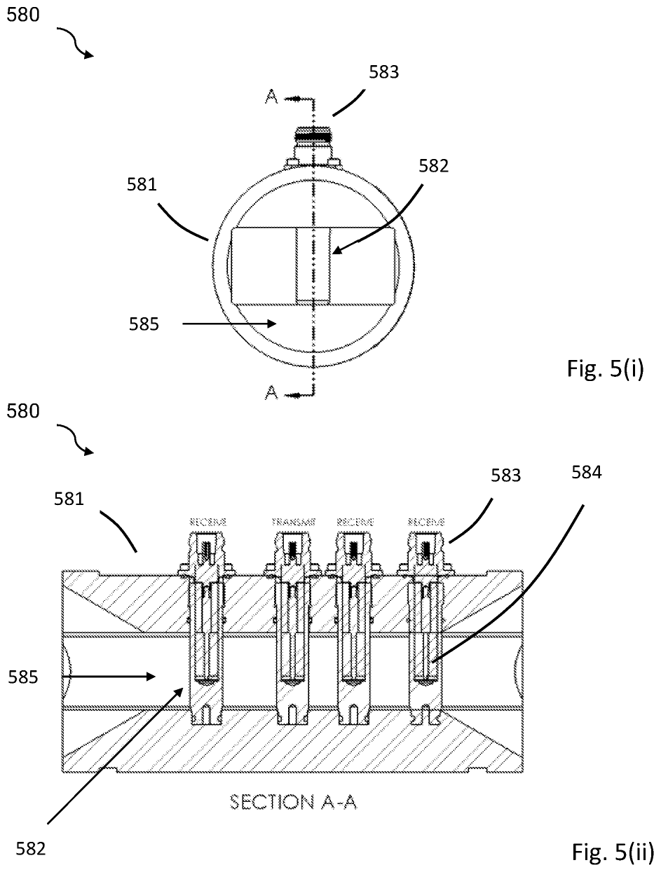

FIGS. 5(i) and 5(ii) illustrate in cross section another embodiment of a water cut meter with four antenna (three receive and one transmit antenna). In this embodiment, the water cut meter 580 has a flow housing 581 with cavity 585, four antennas 584, antenna connectors 583, and protective covering 582. Adding a fourth antenna at a further distance from the transmit antenna compared to either of the two receive antennas improves dynamic range and accuracy in the same way as the transmit/receive switch described above. The electronics can be simplified as no switch is required.

In addition to the accuracy improvements, the additional data provided by the third receive antenna improves the ability to detect wax solid build-up on or between the antennas as the solid will not build up equally. This additional data can also be used to correct for wax build-up.

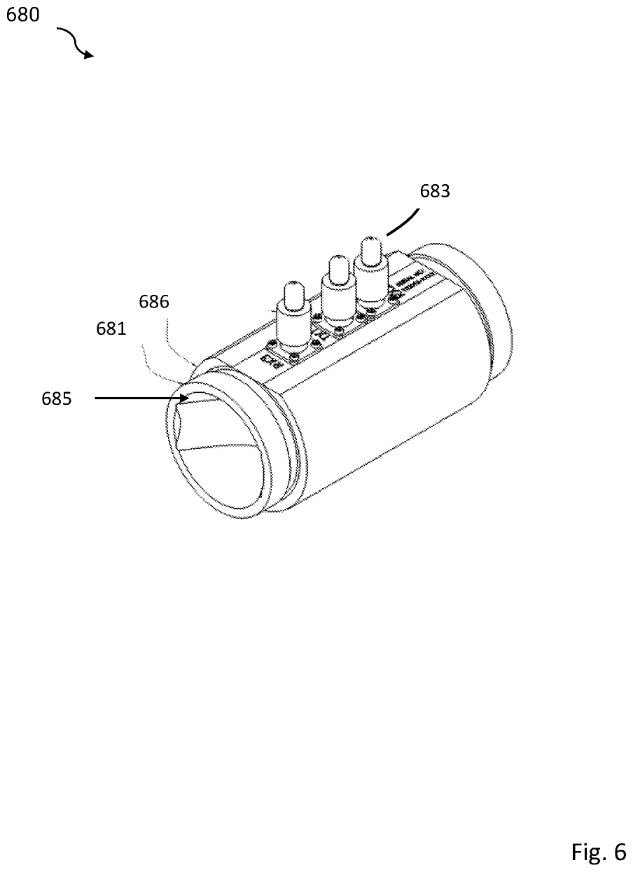

FIG. 6 illustrates a water cut meter 680 with a heating element to assist in waxy solid build up mitigation. In this embodiment, the water cut meter 680 has a flow housing 681 with cavity 685, three antenna (not visible), antenna connectors 683, and heating element 686. Typically, when a measurement device (e.g. water cut meter 680) or fluid pipe is warmer than the fluids flowing through the device, wax solids accumulation inside the device is eliminated or significantly reduced. However, at high fluid flow rates in the device it is very difficult to raise the device temperature. Reducing the fluid flow rate through the device enables effective heating. After the device is heated above the temperature of the fluid the flow rate can be increased to flush out any wax solids that have accumulated inside the device.

Many methods of heating the device are available, including but not limited to application of electrical energy, solar energy, and combustion. For the example below, electrical energy is applied to warm the measurement device, as shown in the measurement device diagram.

Control of fluid flow through the device can be enabled by electronically controlled valves. Using such a system, fluid flow from the well is not interrupted even while the fluid flow through the measurement device is controlled.

Machine learning techniques can be applied to detect waxy solids accumulation and dynamically control the mitigation parameters. The mitigation parameters are the amount of energy applied to heat the device, and the fluid flow rate through the device.

The inside surface of a pipe forming a part of the water cut meter 680, sensors, or system piping in which fluid flows can be polished and chrome plated prior to installation. This results in a very smooth surface that significantly reduces the opportunity for extremely small regions of static liquid near the surface. Solid wax formation is more likely in static regions of liquid so this process reduces the opportunity for waxy build-up.

For electromagnetic propagation control, the inside of the water cut meter 680, sensors, or system piping in which fluid flows and where antennas are located can be a rectangular prism. Piping throughout the rest of the system can be cylindrical. The transition from cylindrical to rectangular prism and back to cylindrical is designed to eliminate regions of static fluid, accelerate the fluid, and increase the turbulence of the fluid, thereby reducing the opportunity for wax solids to form.

As will be understood, various embodiments of previously described components can be used in addition or as a substitute. For example, system 200 can be optionally equipped with density meters that can include nuclear densitometers, vibrating vane densitometers, or Coriolis flow meters that support density measurement. Other suitable meters can include ultrasound or sonar meters that measure density by changes in sound transmission characteristics.

As another example, system 200 can be optionally equipped with a differential pressure meter that can include any type of flow meter that enables flow measurement using a differential pressure. For example, a flow obstruction or restriction can be used to create a differential pressure that is proportional to the square of the velocity of the gas flow in a pipe. This differential pressure across the obstruction, using a pair of pressure sensors, can be measured and converted into a volumetric flow rate. Alternatively or in addition, accelerational pressure drop meter, elbow flow meter, v-cone meter, or comparison of pressures between standard orifices and Venturi devices can be used to measure differential pressure.

As another example, a water cut meter can utilize Coriolis density measurements. In other embodiments, microwave measurements, including resonant microwave oscillator or microwave absorption device can be used.

As another example, a liquid flow meter can include devices which measure aspects and characteristics of flow, including density and viscosity. Coriolis meters including straight or bent tube meters, venturi meters vibratory meters, or other suitable systems can be used. Thermal, turbine, positive displacement, vortex, or ultrasonic meters can be also used.

As another example, system 200 can be optionally equipped with a water conductivity meter can include various electrical components, including electrode pairs or microwave components that allow calculation of conductivity.

As another example, system 200 can be optionally equipped with a chemical sensor can include sensors able to detect carbon dioxide, hydrogen sulfide, or pH. Sensors can be based on electrochemical, chemiresitive, amperometric, resistive, optical changes, or other suitable reactions.

In some embodiments, various other sensor systems can be used, including pressure, strain, or temperature sensors.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A separator and measurement system, comprising:
a separator arranged to separate gas from liquid,
a gas line assembly connected to the test separator to receive gas, with the gas line assembly having a gas flow meter;
a liquid line assembly connected to the test separator to receive liquid;
a water cut meter having a flow housing that defines a cavity, a plurality of antenna connected to the flow housing by antenna connector, and a protective covering for each of the plurality of antenna.

2. The separator and measurement system of claim 1, wherein at least one antenna can be switched between transmit and receive.

3. The separator and measurement system of claim 1, comprising at least three receive antenna and one transmit antenna.

4. The separator and measurement system of claim 1, comprising a heating element to reduce paraffin accumulation.

5. The separator and measurement system of claim 1, comprising gas liquid merge to bring together output from the gas line assembly and the liquid line assembly; and

6. The separator and measurement system of claim 1, wherein gas flow and liquid flow measurements are taken at minute or less intervals.

7. A method of reducing waxy solid accumulation in a separator and measurement system, comprising:
heating a component of the separator and measurement system that supports fluid flow;
reducing the fluid flow rate through the component to above fluid temperature;
increasing flow rate to flush out any waxy solids accumulated inside the component of the separator and measurement system.

8. The separator and measurement system of claim 7, wherein the component includes at least one of a gas line assembly connected to a separator to receive gas, with the gas line assembly having a gas flow meter; and a liquid line assembly connected to the separator to receive liquid.

9. The separator and measurement system of claim 7, wherein the component includes a water cut meter having a flow housing that defines a cavity, a plurality of antenna connected to the flow housing by antenna connector, and a protective covering for each of the plurality of antenna.
